(19) United States
(12) Patent Application Publication
(10) Pub. No.: US 2010/0084042 A1
(43) Pub. Date: Apr. 8, 2010

(54) DISMANTLEABLE APPARATUS FOR TRANSFERRING FLUIDS BETWEEN CONTAINERS

(76) Inventor: Donald G. Bonnell, Glendale, AZ (US)

Correspondence Address: The von HELLENS LAW FIRM, LTD.;C. Robert von Hellens, 7330 N 16TH STREET, SUITE C 201, PHOENIX, AZ, 85020, US

(21) Appl. No.: 12/246,022

(22) Filed: Oct. 6, 2008

(51) Int. Cl. B67C 11/04

(52) U.S. Cl. 141/1; 141/342; 141/332; 141/339; 141/98

(57) ABSTRACT

A combination fluid collector and parts washer includes a collector mounted on a base supported stanchion to receive fluid for selectively discharging the fluid through a valve into a container. A tray is removably mounted in the collector for supporting parts to be washed by the fluid in the collector and includes ridges on the bottom for drainage purposes and holes for draining the fluid from the tray into the collector. A device for collecting fluid from each of a plurality of containers is detachably attachable to the stanchion for discharging the collected fluid into a vessel.

### BACKGROUND OF THE INVENTION

I. Field of the Invention

This invention relates to transfer of fluids between containers and, more particularly, to dismantleable apparatus for storage purposes used to transfer fluids between containers and for using a fluid to clean parts.

II. Description of the Prior Art

During normal maintenance of a powered vehicle, the lubricating oil in the engine and in the transmission should be changed periodically. Oil for these purposes generally sold to the public is packaged in quart containers. The size of such containers renders pouring the lubricating oil into a closeable aperture in the valve cover or into a tube in close communication with the crankcase is relatively easy. Usually, lubricating oil for the transmission is poured into a long thin tube and a funnel is usually used therewith to minimize the likelihood of spillage.

The cost of lubricating oil, whether for an engine or a transmission, has increased significantly. When such oil is packaged in quart containers, the cost per fluid ounce is significantly higher than the cost per fluid ounce in one or five gallon containers. Accordingly, some savings may be effected by buying lubricating oil in larger containers but such larger containers render it difficult and usually messy to transfer oil from a large container into either the engine or the transmission.

Many individuals choose to change oil in the engine and/or transmission of their vehicle rather than going to a commercial facility for this purpose. Before fresh lubricating oil can be introduced, the existing oil must be drained. Engines and transmissions include a threaded plug that can be removed to permit drainage of the existing oil. Most individuals tend to drain the oil, whether from an engine or transmission, into a pan. Disposal of the oil in the pan presents numerous handling problems related to transfer of the used oil into a container suitable to be taken to a disposal facility. To alleviate this problem, there are sealable containers of low height available. Unfortunately, the inlet to such containers is relatively small and spillage of oil often occurs. Additionally, any sloshing of such a container during movement from beneath the vehicle and prior to capping the opening, creates spillage problems.

Lubricating oil is relatively viscous and complete drainage of fresh oil from a quart container takes a certain amount of time. Most persons are sufficiently impatient not to wait for complete evacuation of the oil and the residual oil is discarded. In consequence of a number of oil changes, oil, not in an insignificant amount is discarded and may represent an unacceptable cost.

### SUMMARY OF THE INVENTION

The present invention includes a platform supporting a detachably attached post. An inverted pyramidal shaped collector is slidably mounted on the post and includes a stop cock for controlling drainage. The outlet of the stop cock is sized to discharge lubricating oil into conventional quart containers with little probability of spillage during such drainage. Because the funnel like collector is positionally vertically adjustable, various sized containers for receiving the oil can be accommodated. A tray may be removeably mounted within the collector to support parts to be cleaned with a cleaning fluid disposed in the collector. Upon completion of the cleaning operation, the cleaning fluid is easily discharged into a container for such purpose.

U.S. Pat. No. 4,832,095, describing an invention by the present inventor, discloses a device for collecting fluids from inverted containers and channeling such fluid into a further container. This device may be mounted on the post to reduce waste.

As the platform, post, collector and device are readily dismountable, storage of the invention between periods of use is significantly enhanced.

It is therefore a primary object of the present invention to provide apparatus for transferring fluid from a container into each of a plurality of smaller containers.

Another object of the present invention is to provide an adjustable apparatus for accommodating discharge of fluids into containers of different heights.

Yet another object of the present invention is to provide a post supported collector for washing parts in a cleaning fluid.

Still another object of the present invention is to provide apparatus for distributing oil to be discarded into each of several containers.

A further object of the present invention is to provide a mounting for an oil collection device useable in conjunction with a dismantleable apparatus for collecting oil from each of a variety of containers in a container.

A still yet further object of the present invention is to provide apparatus for transferring a fluid between containers which apparatus is dismountable for storage purposes.

A yet further object of the present invention is to provide a dismantleable apparatus for distributing oil from a large container into each of a plurality of smaller containers.

A yet further object of the present invention is to provide a method for preventing spillage and waste of oil during an oil change in the engine and/or transmission of a vehicle.

These and other objects of the present invention will become apparent to those skilled in the art as the description thereof proceeds.

### BRIEF DESCRIPTION OF THE DRAWINGS

The present invention will be described with greatest specificity and clarity with reference to the following drawings, in which:

FIG. 1 is a prospective view of use of the present invention;

FIG. 2 is a side view of the present invention;

FIG. 3 is a detailed view of a selectively useable filter;

FIG. 4 illustrates a device for collecting oil from a plurality of containers mounted upon the post of the present invention;

FIG. 5 is a partial cross-sectional view of the device shown in FIG. 4 and the post;

FIG. 6 is an end view taken along lines 6-6 as shown in FIG. 5;

FIG. 6a is a partial cross-sectional view taken along lines 6a-6a, as shown in FIG. 6;

FIG. 7 is a perspective view illustrating the collector used for cleaning purposes;

FIG. 8 is a top view of the tray mountable within the collector, as shown in FIG. 7;

FIG. 9 illustrates a section of the tray for attachment to the collector;

FIG. 10 is a partial cross-sectional view illustrating a conventional automotive oil filter placed upon the tray for drainage purposes; and

FIG. 11 is a partial view illustrating the cleaning of a part.

### DESCRIPTION OF THE PREFERRED EMBODIMENT

Referring to FIG. 1, there is illustrated apparatus 10 for collecting a fluid from a container 12 into a flask 14; it is to be understood that the element identified by the term flask could be any type of capped or uncapped container. Apparatus 10 includes a base 20 for supporting a post 22. The post nests within a cylinder 24 extending from base 20. Set screws 26, or the like, extend through cylinder 24 into locking engagement with the post to permit insertion and withdrawal from the post.

As further shown in FIG. 2, a collar 30 is slidably mounted upon post 22 and includes a set screw 32 for lockingly engaging the collar with the post at a selected height. A collector 34 is engaged with collar 30 through a support 36. Accordingly, the vertical location of collector 34 relative to base 20 is a function of the location at which collar 30 is locked onto post 22. As particularly illustrated in FIG. 1, the collector is generally in the shape of an inverted hollow pyramid having an opening 40 serving in the manner of an inlet for fluid poured thereinto and an outlet 42 for discharging the fluid, as depicted by arrow 44 shown in FIG. 1. A valve 46, such as a ball valve shown, controls flow of fluids from within collector 40 through conduit 48 to outlet 42. A lid 50 covers opening 40 to prevent deposit of foreign matter within collector 34 that might contaminate or otherwise compromise the integrity of the fluid flowing therethrough. Obviously, the lid would be removed, as shown in FIG. 1, during use of apparatus 10.

As will be described in further detail below, apparatus 10 may be used for cleaning parts with cleaning fluid disposed within collector 34. In conjunction therewith, or in the normal course, a screen 58 may be mounted in a holder 60 which holder is placed adjacent bottom surface 62 of collector 34. Necessarily, screen 58 is essentially coincident with opening 64 in the bottom surface.

In operation, apparatus 10 is particularly useful to empty fluid from a large container 12 into each of a plurality of smaller sized flasks 14. As depicted in FIG. 1, fluid is poured into collector 34. Thereafter, a flask 14 or other container to receive some or all of the fluid is placed beneath outlet 42. Upon opening of valve 46, the fluid will flow into the container until the fluid level therein is commensurate with the intentions of an operator. Thereafter, valve 46 is closed. The flask or container may then be removed and capped for further use of the fluid contained therein. It may be noted that filter 58 may be present, as depicted, to reduce the likelihood of flow of any contaminants within collector 34 into the flask 14 or other container. Preferably, outlet 42 is cut on the bias to control dripping at a certain point at the outlet and thereby ensure that the inlet of the flask is aligned with the lower most point of outlet 42 to prevent spillage and avoid contamination of base 20 and the exterior of flask 14.

The present inventor obtained U.S. Pat. No. 4,832,095 for a device 70 which accommodates collection of residual oil from a plurality of upturned containers. This device is primarily depicted in FIGS. 4, 5, 6 and 6a and a description of its use in conjunction with apparatus 10 will be described. Device 70 is configured as a closed hollow inverted pyramidal shape serving in the manner of a funnel 72. A plurality of inlets 74 are formed in a top surface 76 for engagement with the outlets in the neck of each of a plurality of conventional quart size oil containers 78 (or other container). Over a period of time, the oil within containers 78 will migrate downwardly and into funnel 72. The funnel includes an outlet 80 for a threaded engagement with a neck 82 of a further container serving in the manner of a depository 84. Thereby, the residual oil within containers 78 will migrate over a period of time into depository 84 for subsequent use.

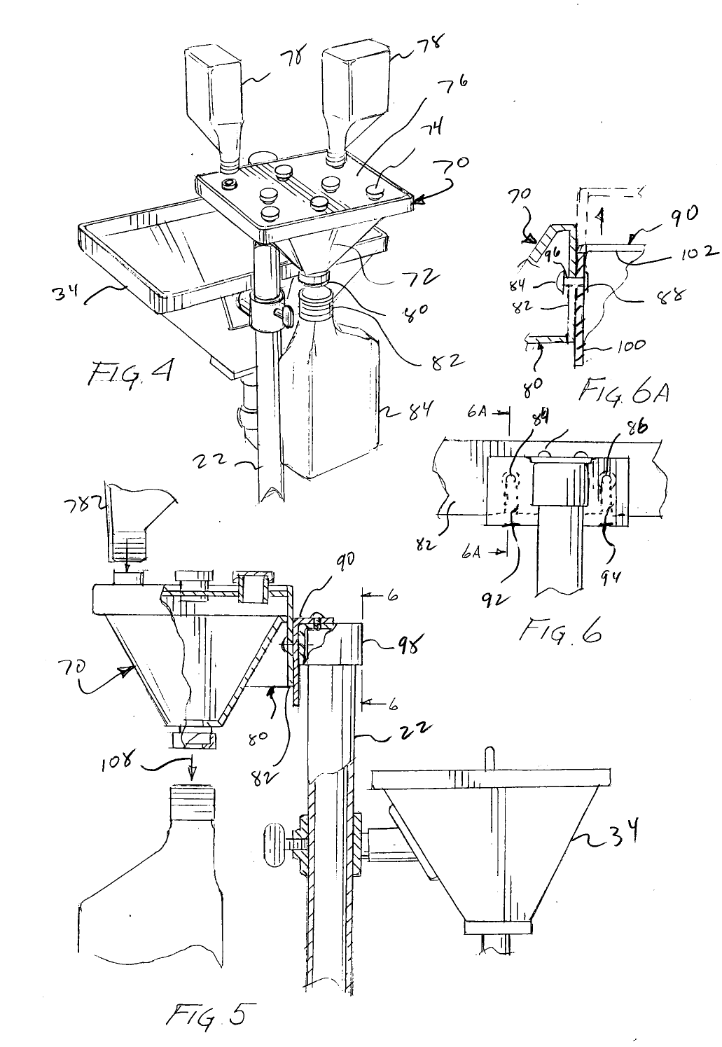

Device 70, as shown in FIG. 5, includes a support 80 for mounting the device on a stanchion or the like. The support includes a vertical side wall 82 and a pair of downwardly extending slots 92, 94 formed therein. A right angle brace 90 includes a pair of rivets 84, 86, or the like, extending laterally from a side wall 100. Each of these rivets includes a shank 96 for sliding engagement into one of slots 92, 94. Wall 102 of brace 90 is secured to the top of cap 98 by a pair of rivets 104, 106 or the like. Cap 98 is configured to receive the upper end of post 22, as shown in FIG. 5.

In operation, device 70 is attached to the post by first engaging cap 98 with the upper end of the post. Thereafter, support 80 of device 70 is brought into engagement by slots 92, 94 engaging rivets 84, 86 to receive support therefrom. After such attachment, containers 78 may be mounted upon the device, as shown in FIG. 4. Any residual oil in these containers will migrate over time into the device for discharge into depository 84, as depicted by arrow 108.

As illustrated in FIG. 5, apparatus 10 may be used simultaneously to collect oil from a plurality of containers while accommodating transfer of fluid from one container, such as container 12 as shown in FIG. 1, to flask 14. After use, apparatus 10 may be dismantled for storage purposes. Furthermore, apparatus 10 may be used to transfer fluid independent of the operation of collecting fluid and vice versa.

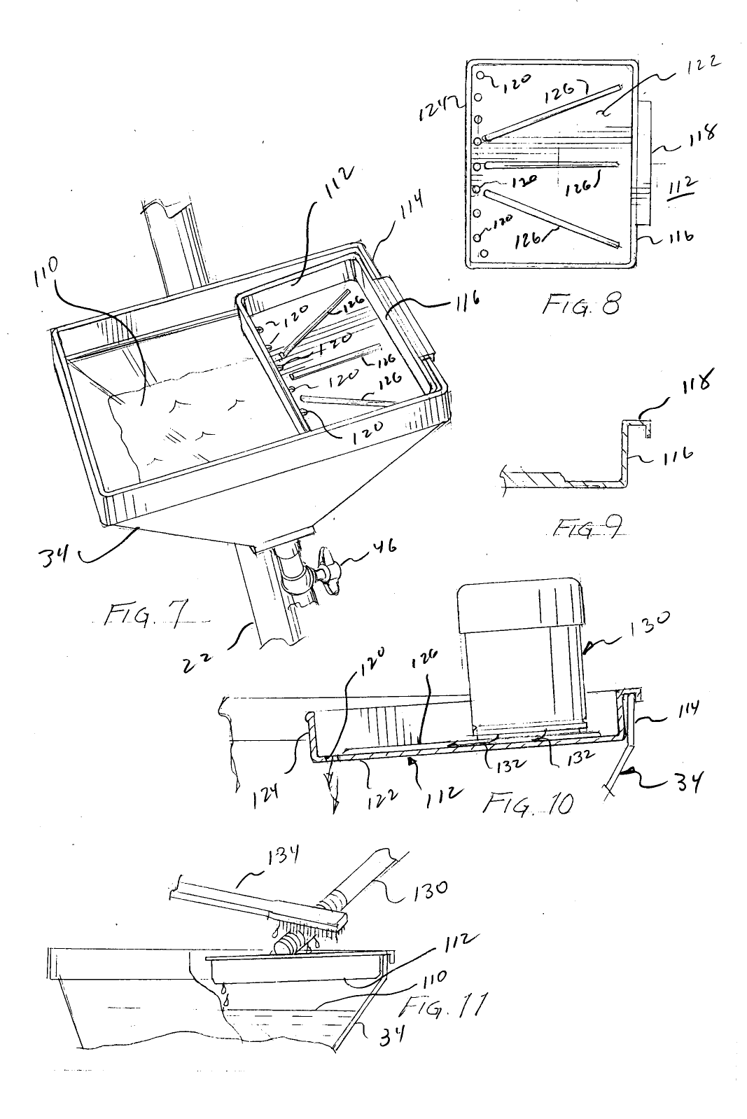

Referring jointly to FIGS. 7, 8, 9, 10 and 11, the use of apparatus 10 for cleaning parts will be described in detail. Collector 34 may be filled in part with a cleaning fluid 110 particularly adapted for use on the parts to be cleaned. To assist in the cleaning function, a tray 112 may be dependingly attached to side 114 of collector 34.

As particularly shown in FIGS. 7, 8, 9 and 10, tray 112 includes a side wall 116 having a lip 118 extending therefrom for supported engagement with side 114. As particularly shown in FIG. 10, with this mating arrangement, tray 112 tends to be tilted downwardly within collector 34. A plurality of holes 120 are disposed in bottom 122 generally adjacent wall 124. As shown in FIG. 10, the holes are at essentially the lowest point within the tray when the tray is mounted within the collector and drainage from within the tray of cleaning fluid is enhanced. A plurality of ribs 126 may be disposed in bottom 122 to support a part being cleaned, such as part 130 shown in FIG. 10. Moreover, if part 130 is a conventional oil filter used in an engine, it may be placed in tray 112 upon ribs 126 to permit drainage, as depicted by arrows 132.

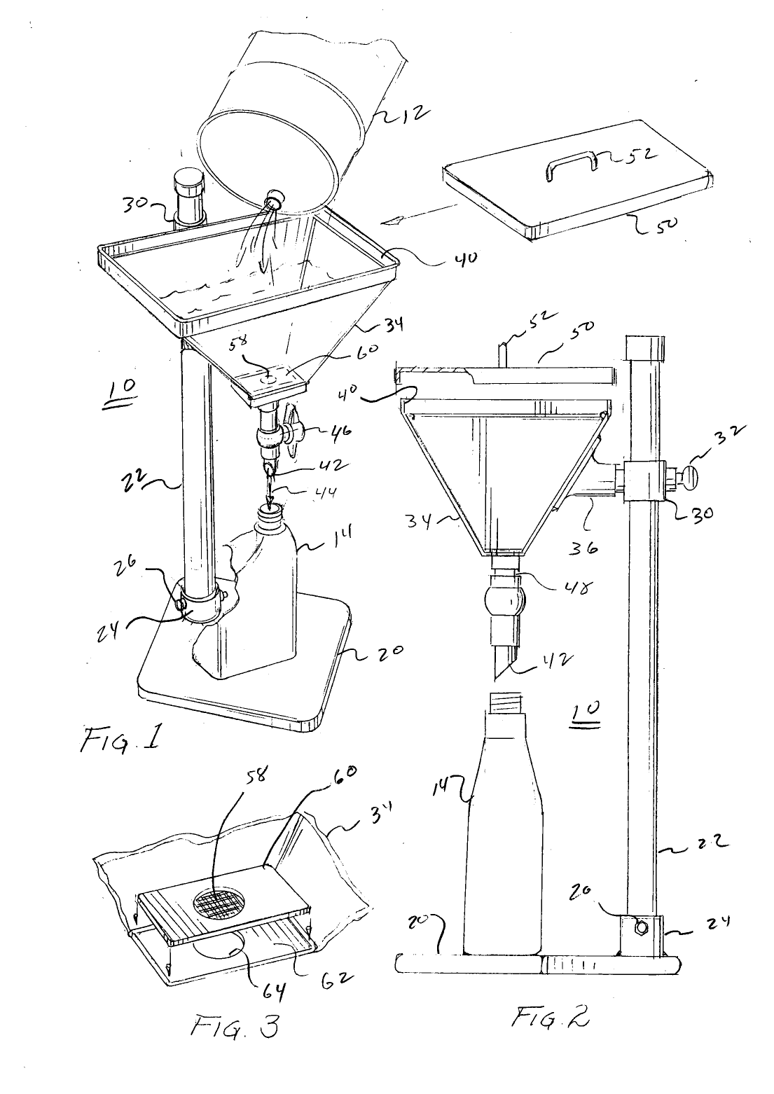

As particularly shown in FIG. 11, a part 130 may initially be dipped or soaked in cleaning fluid 110 within collector 134 to assist in loosening any debris thereupon. Thereafter, the part may be brushed with a brush 134 to assist in removing the debris. It is to be understood that the brush, as well as parts 130, may be periodically dipped in cleaning fluid 110 to enhance cleaning of the part. By cleaning the part over tray 112, the debris removed may be viewed. Moreover, the tray can serve as a support for parts 130 during the cleaning operation. As discussed above, the cleaning fluid along with any debris therein will drain through holes 120 into collector 134. By use of filter 58 (see FIG. 3), debris larger than a predetermined size will be filtered from the cleaning fluid ultimately discharged through valve 46 into a container, flask or other receiving element.

I claim:

1. An apparatus for receiving a fluid and selectively channeling the fluid into a container, said apparatus comprising in combination:
a) a stand having a base and a stanchion extending from said base;
b) a collector for receiving fluid to be channeled into the container;
c) a positionable clamp for attaching said collector to said stanchion at a selectable location;
d) an outlet extending from said collector for discharging the fluid into the container; and
e) a valve adapted to control flow of fluid through said outlet.

2. The apparatus as set forth in claim 1, including a screen for filtering inflow of the fluid to said outlet.

3. The apparatus as set forth in claim 1, wherein said base is adapted to support the container in functional engagement with said outlet.

4. The apparatus as set forth in claim 1, wherein said stanchion is detachably attached to said base and wherein said clamp is slidably disengageably engaged with said stanchion, whereby said apparatus is dismantleable for storage and erectable for use.

5. The apparatus as set forth in claim 2, wherein said collector is in the form of an inverted pyramid.

6. The apparatus as set forth in claim 1, including a cover engageable with said collector.

7. The apparatus as set forth in claim 1, including a device mountable upon said stanchion for collecting fluid from each of a plurality of containers, said device comprising a funnel member, a top portion adapted to receive the outlet of each of a plurality of invented containers, and an outlet for discharging the fluid collected into a vessel, and a fitting for supporting said device on said stanchion.

8. The apparatus as set forth in claim 7, wherein said fitting includes an element detachably attachable to said stanchion.

9. The apparatus as set forth in claim 8, wherein said element includes a cap adapted for engagement with the top of said stanchion.

10. The apparatus as set forth in claim 9, wherein said cap is detachably attached to said device.

11. Apparatus serving as a parts washer and fluid collector, said apparatus comprising in combination:
a) a stand having a base and a stanchion extending from said base;
b) a collector for selectively retaining and discharging a fluid;
c) a clamp for attaching said collector to said stanchion at a selectable height;
d) an outlet extending from said collector for discharging the fluid;
e) a valve adapted to control the flow of fluid through said outlet; and
f) a tray for supporting an item to be washed, said tray including a receiver for receiving a part of said collector to support said tray within the open end of said collector.

12. The apparatus as set forth in claim 11, wherein said tray includes a bottom surface and ridges on said bottom surface for supporting the item to provide a space between the item and said bottom surface and drain holes in said bottom surface.

13. The apparatus as set forth in claim 12, including a filter disposed in said collector for filtering fluid flowing to said outlet.

14. An apparatus for receiving a fluid and selectively channeling the fluid into a container, said apparatus comprising in combination:
a) a stand having a base and a stanchion extending from said base;
b) a cylinder mounted on said base for receiving one end of said stanchion to detachably attach said stanchion to said base;
c) a collector for receiving fluid to be channeled into the container;
d) a positionable clamp for detachably attaching said collector to said stanchion at a selectable location;
e) an outlet extending from said collector for discharging the fluid into the container; and
f) a valve adapted to control flow of fluid through said outlet.

15. The apparatus as set forth in claim 14, including a screen for filtering inflow of the fluid to said outlet.

16. The apparatus as set forth in claim 14, wherein said base is adapted to support the container in functional engagement with said outlet.

17. The apparatus as set forth in claim 14, wherein said clamp is slidably disengageably engaged with said stanchion, whereby said apparatus is dismantleable for storage and erectable for use.

18. The apparatus as set forth in claim 17 including a set screw for retaining the end of said stanchion within said cylinder.

19. The apparatus as set forth in claim 14, wherein said collector is in the form of an inverted pyramid.

20. The apparatus as set forth in claim 14, including a device detachably attachable to the other end of said stanchion for collecting fluid from each of a plurality of containers, said device comprising a funnel member, a top portion adapted to receive the outlet of each of a plurality of inverted containers, and an outlet for discharging the fluid collected into a vessel, and a fitting for detachably attaching said device with said stanchion.

21. The apparatus as set forth in claim 20, wherein said fitting includes a cap adapted for engagement with the top of said stanchion.

22. The apparatus as set forth in claim 21, wherein said cap is detachably attached to said device.

23. A method for transferring a fluid from a container to at least one further container, said method comprising the steps of:
a) detachably attaching a stanchion to a base;
b) mounting a collector for receiving the fluid on the stanchion;
c) pouring the fluid from the container into the collector;
d) controlling the flow of fluid from the collector through a valve;
e) collecting the fluid flowing from the valve into a further container;
f) closing the valve on completion of exercise of said step of collecting;
g) dismantling the collector from the stanchion on completion of said step of collecting; and
h) detaching the stanchion from the base.

24. The method as set forth in claim 24 including the step of exercising said step of detaching on completion of said step of dismantling.

25. The method as set forth in claim 23 including the step of mounting a device upon the stanchion for collecting a fluid from a plurality of containers and the step of channeling the collected fluid into a further container.

26. The method as set forth in claim 25 including the step of detachably attaching a cap to the device and the steps of mounting and dismantling the cap at the top of the stanchion.
